(19) United States
(12) Patent Application Publication
(10) Pub. No.: US 2020/0130891 A1
(43) Pub. Date: Apr. 30, 2020

(54) Capsule for Bottle and Apparatus for Use with Capsule

(71) Applicants: Amin I. Kassis, Chestnut Hill, MA (US); Sousan Kanbar, Chestnut Hill, MA (US); Lana Kassis, Chestnut Hill, MA (US); Maya Kassis, Chestnut Hill, MA (US)

(72) Inventors: Amin I. Kassis, Chestnut Hill, MA (US); Sousan Kanbar, Chestnut Hill, MA (US); Lana Kassis, Chestnut Hill, MA (US); Maya Kassis, Chestnut Hill, MA (US)

(21) Appl. No.: 16/686,764

(22) Filed: Nov. 18, 2019

Related U.S. Application Data
(62) Division of application No. 15/774,162, filed on May 7, 2018.
(60) Provisional application No. 62/328,871, filed on Apr. 28, 2016.
(60) Provisional application No. 62/251,254, filed on Nov. 5, 2015.

(51) Int. Cl. B65D 23/06; B65D 47/40; B65D 47/14; B65D 51/18; B65D 41/32

(52) U.S. Cl. CPC B65D 23/065; B65D 47/40; B67B 2007/0458; B65D 51/18; B65D 41/32; B65D 47/14

(57) ABSTRACT

A capsule for covering the top of a bottle includes a lower portion configured to wrap about a neck of the bottle, an upper portion connected to the lower portion and configured to be removed from the lower portion to expose a top of the neck, and a trench formed about a periphery of an upper edge of the lower portion. An assembly used to form the trench in the capsule includes a housing, and a blade extending outwardly from the housing.

### RELATED APPLICATION DATA

This application claims priority to U.S. Provisional Patent Application No. 62/251,254, filed on Nov. 5, 2015 and U.S. Provisional Patent Application No. 62/328,871, filed on Apr. 28, 2016, each of which is incorporated herein by reference in its entirety for all purposes.

### FIELD

Aspects of this invention relate generally to a device for the collection of drips of fluid that run down the side of a container after dispensing of the fluid present within the container, and more particularly to a capsule to be secured about a neck of a bottle.

### BACKGROUND

Bottles used for wine typically come in either a corked or screw cap configuration. In either case, the top of the bottle typically includes a protective sleeve, which is often referred to as a foil or a capsule. A common annoying problem with such bottles relates to the pouring of red wine (and other liquids that may stain a surface, e.g., colored, oily, acids, bases, etc.). This action is often accompanied by the dripping of one or more drops of the liquid, which may then run onto other surfaces such as a table cloth, for example. To avoid this, individuals usually use a piece of clothing/tissue to immediately wipe the neck of the bottle.

To avoid this problem, a number of devices have been proposed. For example, U.S. Pat. No. 1,182,993 discloses a drip guard for a bottle including an absorbent elastic band. U.S. Pat. No. 4,437,583 discloses a dribble ring made of an absorbent foam. U.S. Pat. No. 5,484,635 discloses a drip catcher shaped as a pocket filled with an absorbent material that is adhesively attached to the outside of the container. U.S. Pat. No. 5,651,481 described a drip-catcher that includes a piece of flexible and elastic foil material that is rolled into a cylindrical form and inserted into the orifice of the bottle. U.S. Pat. No. 6,325,247 described a device that comprises a band of absorbent material permanently placed around the neck of the bottle in close proximity to its orifice and that is covered by a capsule. Once the capsule is removed, the absorbing material becomes exposed and serves to absorb any droplets. In another embodiment, absorbent material is applied to the inside of a capsule. Bodechon (U.S. patent D689,339 S) described an ornamental wine bottle drip collar. Finally, Toti and Pellonara (WO patent publication 2014/170240) described absorbent devices that are inserted around the neck of bottles while Man et al. (U.S. patent publication 2008/0314924) and Long et al. (U.S. patent publication 2014/0319007) described a drop-retaining sponge-made collar for catching any drips.

It would be desirable to provide a device for capturing drops of liquid when the contents of a bottle are poured out of the bottle that reduces or overcomes some or all of the difficulties inherent in prior known devices. Particular advantages will be apparent to those skilled in the art, that is, those who are knowledgeable or experienced in this field of technology, in view of the following disclosure of the invention and detailed description of certain embodiments.

### SUMMARY

The principles of the invention may be used to advantage to provide a capsule having a trench that captures drops of liquid after liquid has been poured out of a bottle. An assembly for forming the trench may have a housing, and a blade, with the blade being used to create the trench in the capsule. According to one aspect, the disclosure provides an assembly or device for forming a trench in a capsule surrounding the neck of a bottle. The assembly or device for forming the trench has dimensions sufficient for the assembly or device to fit or engage on top of the bottle neck, such as in a snug manner, or match the thickness of the glass wall of the neck of the bottle.

In accordance with a first aspect, a capsule to be secured about a neck of a bottle includes a lower portion configured to be secured about a neck of a bottle, an upper portion connected to the lower portion and configured to be removed from the lower portion to expose a top of the neck, and a trench formed about a periphery of an upper edge of the lower portion.

In accordance with another aspect, an assembly for forming a trench in a capsule to be secured about a neck of a bottle includes a housing, and a blade extending outwardly from the housing.

By providing a capsule with a trench, and an assembly with a blade for forming such a trench, drops of liquid that form at the lip of a bottle after liquid has been poured out of the bottle can be captured in the trench, thereby reducing the chances of liquid such as red wine from dripping onto, and staining materials, such as tablecloths and/or clothing. These and additional features and advantages disclosed here will be further understood from the following detailed disclosure of certain embodiments.

### BRIEF DESCRIPTION OF THE DRAWINGS

FIGS. 1A-H are plan views of embodiments of a capsule for a bottle configured to include a trench to capture drops of liquid.

FIGS. 2A-B are plan views of an alternative embodiment of the capsule of FIG. 1.

FIGS. 3A-O are plan views of alternative embodiments of the capsule of FIG. 1.

FIGS. 4A-D are plan views of an assembly used to form a trench in the capsule of FIG. 1.

FIGS. 5A-I are plan views of alternative embodiments of the assembly of FIG. 4, which include a cylindrical housing.

FIGS. 6A-G are plan views of other alternative embodiments of the assembly of FIG. 4, which include a cylindrical housing.

FIG. 7 is a plan view of a bottle with a capsule secured thereto. The top of the capsule may be removed.

FIGS. 8A-D are plan views of an alternative embodiment of the assembly of FIG. 4 and its use in forming a trench, which includes a T-shaped housing.

FIGS. 9A-C are plan views of an alternative embodiment of the assembly of FIG. 4 and its use, which includes a housing with opposed walls separated by a spring.

FIGS. 10A-C are plan views of another alternative embodiment of the assembly of FIG. 4 and its use, which includes a housing with opposed walls separated by a spring.

FIGS. 11A-D are plan views of yet another alternative embodiment of the assembly of FIG. 4 and its use, which includes a housing with walls connected by hinges.

FIGS. 12A-D are plan views of a further alternative embodiment of the assembly of FIG. 4 and its use, which includes a flexible U-shaped housing.

FIGS. 13A-B are plan views of an alternative embodiment of the assembly of FIG. 4 and its use, which includes a movable blade.

FIGS. 14A-B are plan views of another embodiment of the assembly of FIG. 4 and its use, which includes a movable sleeve.

FIGS. 15A-B are plan views of an alternative embodiment of the assembly of FIG. 4 and its use, which includes a bottle opener.

FIGS. 16A-B are plan views of another alternative embodiment of the assembly of FIG. 4 and its use, shown with a plurality of blades.

FIG. 17 is a plan view of an alternative embodiment of the assembly of FIG. 4, shown with a heater.

FIGS. 18A-B are plan views of an alternative embodiment of the assembly of FIG. 4, shown with a heater and movable walls that capture a bottle.

FIGS. 19A-B are plan views of an alternative embodiment of the assembly of FIG. 4, shown with a corkscrew and movable walls that capture a bottle.

FIGS. 20A-D are plan views of alternative embodiments of the blade of the assembly of FIG. 4.

FIGS. 21A-B are plan views of an alternative embodiment of the assembly of FIG. 4, shown in use with a movable cap.

FIGS. 22A-B are plan views of an alternative embodiment of the assembly of FIG. 4, which include a capsule cutter.

FIG. 23 is a plan view of an alternative embodiment of the assembly of FIG. 4, shown with a corkscrew bottle opener.

FIG. 24 is a plan view of another embodiment of the assembly and bottle opener of FIG. 23.

FIG. 25 is a plan view of another embodiment of the assembly and bottle opener of FIG. 23.

FIGS. 26A-B are plan views of an alternative embodiment of the assembly of FIG. 4, which include a pivotable wall.

FIG. 27 is a plan view of an alternative embodiment of the assembly of FIG. 4, which includes a T-shaped housing to which pivotable walls are attached.

FIG. 28 is a plan view of an alternative embodiment of the assembly of FIG. 4, which includes a U-shaped housing with flexible walls.

FIG. 29 is a plan view of an alternative embodiment of an inner ring positioned within the capsule of FIG. 1, shown positioned above a bottle.

FIG. 30 is a section view of an alternative embodiment of an inner ring positioned within the capsule of FIG. 1, with the ring being a part of a synthetic cork.

The figures referred to above are not drawn necessarily to scale, should be understood to provide a representation of particular embodiments of the invention, and are merely conceptual in nature and illustrative of the principles involved. Some features of the capsule with a trench, and the housing with a blade used to form the trench depicted in the drawings have been enlarged or distorted relative to others to facilitate explanation and understanding. The same reference numbers are used in the drawings for similar or identical components and features shown in various alternative embodiments. Capsules and housings with a blade used for forming a trench in a capsule as disclosed herein would have configurations and components determined, in part, by the intended application and environment in which they are used.

### DETAILED DESCRIPTION OF CERTAIN PREFERRED EMBODIMENTS

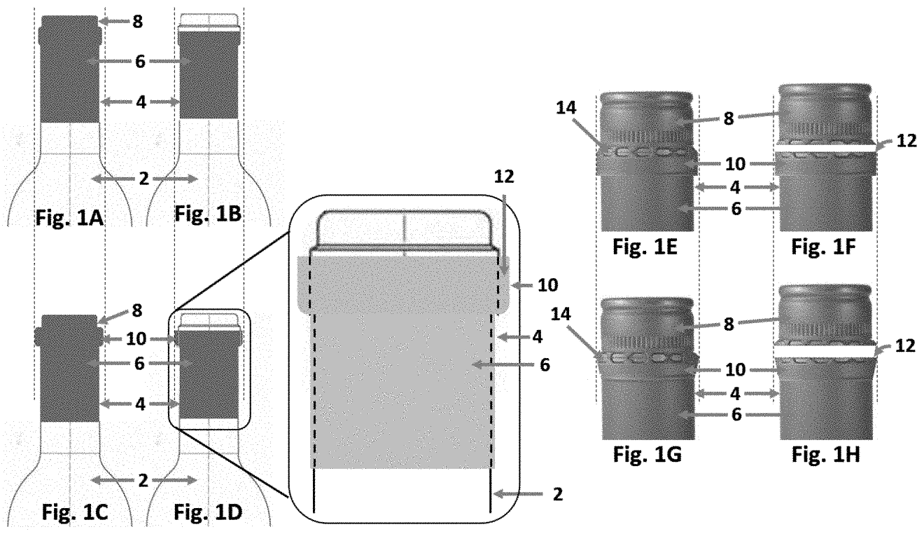

FIG. 1A shows a bottle 2, such as a wine bottle, for example, with a standard capsule 4 covering an upper end and neck of bottle 2, with capsule 4 including a lower portion 6 and an upper portion 8. FIG. 1B shows bottle 2 with upper portion 8 of capsule 4 removed, thereby exposing bottle 2's orifice, which may have a cork therein. FIG. 1C shows capsule 4 with a top portion 10 of lower portion 6 having an inner diameter that is larger than that of the external diameter of the neck of bottle 2, thereby defining a trench 12 about a periphery of an upper edge of lower portion 6. FIG. 1D shows bottle 2 with upper portion 8 removed from capsule 4, thereby exposing trench 12.

Trench 12 may be ≥0.1 mm high, and ≥0.01 mm wide, and may be cylindrical, trapezoidal, or any similar shape. Once the liquid has been poured, any droplets sliding along the neck of bottle 2 will seep into trench 12, thus circumventing the dripping of one or more drops of the liquid onto a surface (e.g., table cloth).

Capsule 4 may be formed of a thin (e.g., <500 μm) polyvinyl chloride (PVC), expandable polyethylene (EPE), tin, aluminum, or similar material. Top portion 10 may, in certain embodiments, be fortified to strengthen it, i.e., made of material that is thicker and/or stronger than that from which the remainder of capsule 4 is made of. Once fabricated, such capsules 4 may be useful to winemakers and the likes to cap the orifices of liquid containers.

FIGS. 1E-H show an embodiment in which capsule 4 is a screw cap for used on a threaded bottle 2. As seen here, capsule 4 includes a weakened region 14 that defines a boundary between lower portion 6 and upper portion 8. In certain embodiments, weakened region 1 may be formed as perforations in capsule 4. Note that once upper portion 8 of capsule 4 has been unscrewed and removed, the now exposed trench 12 becomes available to capture/receive any droplets.

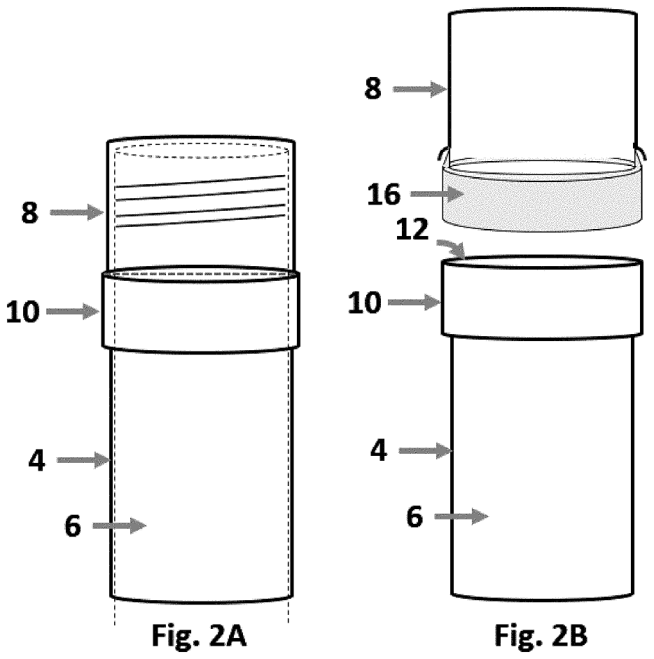

FIGS. 2A-2B depict another embodiment of capsule 4 for use with a screwcap bottle 2, in which capsule has a threaded upper portion 8. That is, an interior of upper portion 8 is threaded to mate with external threads on bottle 2. As seen here, upper portion 8 includes an inner sleeve 16 that extends downwardly from upper portion 8, and is received in trench 12 when upper portion 8 and lower portion 6 are connected (as seen in FIG. 2A). Inner sleeve 16 may be used to form trench 12 in lower portion 6.

Inner sleeve 16 may be made of a material (e.g., cardboard, metal, plastic, and other similar material) whose shape and dimensions are not altered by the capping or other procedures used to cap bottle 2, and have a thickness of e.g., ≥0.01 mm, a height of e.g., ≥0.1 mm, a width of e.g., ≥0.1 mm, and a cylindrical, trapezoidal, or a similar shape. In this embodiment, as an operator unscrews upper portion 8 and removes it, thereby opening bottle 2, inner sleeve 16 will simultaneously rotate and is removed together with upper portion 8, thereby exposing trench 12, within which inner sleeve 16 was contained. Another function served by inner sleeve 16 is to prevent any inadvertent damage to top portion 10 with trench 12 prior to de-capping of the screwcap bottle 2 (e.g., during shipping or storage). Note that once upper portion 8 has been removed, the liquid (e.g., wine) is poured, and bottle 2 is tilted back to its vertical position, any droplets formed at the orifice of bottle 2 that slide down the neck will seep into the newly formed trench 12, thereby circumventing the dripping of one or more drops of the liquid onto a surface (e.g., table cloth).

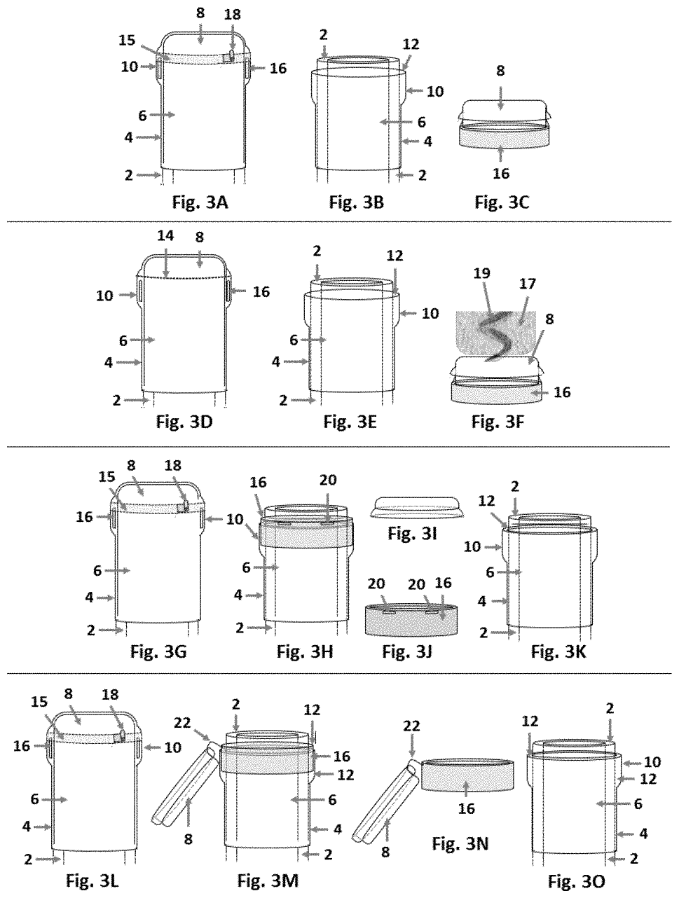

FIGS. 3A-3C depict yet another non-screwcap embodiment (e.g., corked bottle) in which weakened region 14 is formed of a detachable ring or strip 15 with perforations along its upper and lower edges. A tongue or tab 18 is attached to strip 15 and is used to tear away strip 13, and enable the facile detaching of upper portion 8 of capsule 4 without the use of a slicing device, e.g., knife, and the subsequent exposure of the orifice of bottle 2. Once strip 15 has been torn off, the operator removes upper portion 8 and inner sleeve 16 as described above with respect to FIGS. 2A-B.

It should be noted that the operator may choose to leave upper portion 8 and inner sleeve 16 in place after strip 15 has been torn off and removes cork 17 from bottle 2 with a corkscrew 19. The advantage of this approach is that it protects trench 12 from any inadvertent damage that may occur during the uncorking of bottle 2. In this situation, inner sleeve 16 will be simultaneously removed together with the cork (through the use of a cork screw), a process that leads to trench 12 becoming exposed and available to capture any liquid droplets that may seep down the neck of bottle 2 following the pouring of the liquid contents present within.

FIGS. 3D-3F depict yet another embodiment in which capsule 4 is a non-screwcap member, and includes a weakened region 14. In use, the operator uncorks the bottle without slicing off upper portion 8 of capsule 4. In doing so, inner sleeve 16 is simultaneously removed together with the cork (with the use of a cork screw), a process that leads to trench 12 becoming exposed. Thus, there is no need to slice off upper portion 8 of capsule 4 by the use of a knife for example prior to uncorking the bottle.

FIGS. 3G-3K depict yet another embodiment in which capsule 4 covers a non-screwcap corked bottle 2 and has within its structure the detachable strip 15. In this embodiment, inner sleeve 16 is not attached to upper portion 8 and resides freely within trench 12 and protects trench 12 from any inadvertent damage prior to detaching upper portion 8 (e.g., during shipping or storage) as well as during the de-corking of bottle 2. Once strip 15 has been torn off and the operator removes and disposes of strip 15, removes and disposes of upper portion 8 (FIG. 3I), and exposes the orifice of the corked bottle 2 (FIG. 3H), the top portion of inner sleeve 16 will be exposed (see FIGS. 3H & 3J). At this point, most of inner sleeve 16 is still contained within trench 12 and is covered by lower portion 6 (see FIG. 3H). Inner sleeve 16 has one or more openings or depressions 20. To facilitate removal of inner sleeve 16, the operator inserts any available pointed device (e.g. tip of a corkscrew, a knife, etc.) into an opening 20, unpins inner sleeve 16 from trench 12, and disposes it. FIG. 3K is a view of lower portion 6 of capsule 4 wrapped around the neck of bottle 2 after upper portion 8 and inner sleeve 15 have been removed, showing trench 12.

FIGS. 3L-3O depict yet another embodiment in which capsule 4 covers a non-screwcap corked bottle 2 and has within its structure the detachable strip 15. In this embodiment, inner sleeve 16 is attached to upper portion 8 with a flexible member or cord 22. Once strip 15 has been torn off, the operator moves or flips upper portion 18 away from the top of bottle 2, thereby exposing the orifice of the corked bottle 2 and the top portion of inner sleeve 16 (note that most of inner sleeve 16 is still contained within trench 12 is covered by lower portion 6, see FIG. 3M). With the cord-attached upper portion 8 hanging by the neck of bottle 2 (FIG. 3M), the operator proceeds to de-cork the bottle and then removes the disposable upper portion 8 and inner sleeve 16 from trench 12. FIG. 3O is a view of lower portion 6 wrapped around the neck of bottle 2 after upper portion 8 and inner sleeve 16 have been removed.

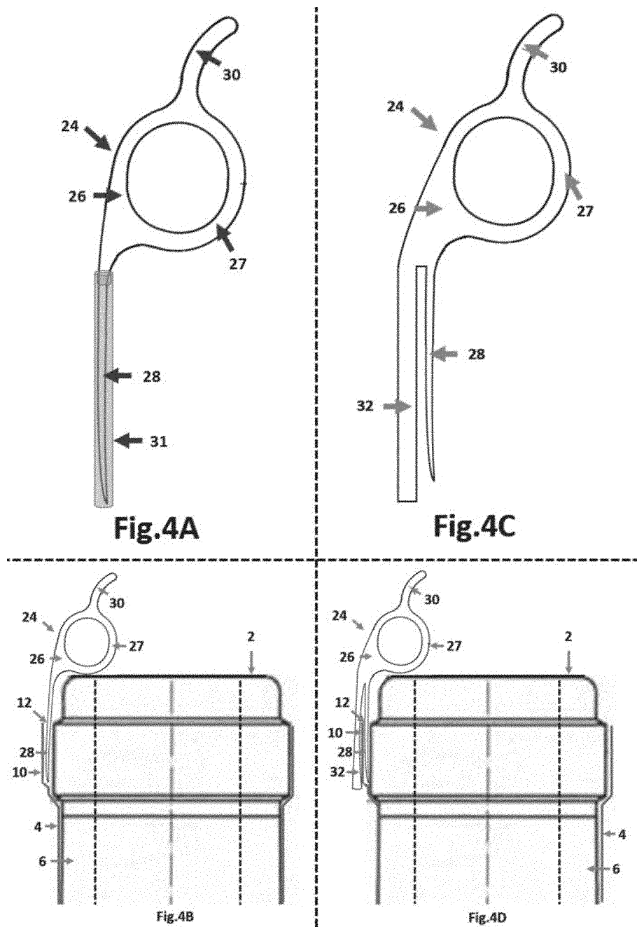

FIGS. 4A-4D show an assembly 24 for forming trench 12 in capsule 4. Assembly 26 includes a housing 26 and a spatula or blade 28 extending outwardly from housing 26. In certain embodiments, housing 26 may be sized so that a user's finger can be inserted into the device. As shown here, housing 26 may be a finger ring 27 in which the operator's finger is inserted. Blade 28 may be a malleable or rigid thin element (e.g., ≥0.01 mm thick, ≥0.1 mm high, and ≥0.1 mm wide-flat/circular arc in shape) that extends from ring 27 and that can be used to form trench 12 within lower portion 6 which is wrapped around the neck of bottle 2, as seen in FIG. 4B. A finger support such as an arm 30 may extend outwardly from ring 27 in a direction substantially opposite the direction that blade 28 extends. Arm 30 is used to stabilize the device within the hand of the operator when it is being used. Arm 30 may be curved to more comfortably fit around the user's finger.

In certain embodiments, a removable protective sleeve 31 may be placed over blade 28 to protect it when it is not in use. Once the user detaches upper portion 8 of capsule 4, exposes the bottle's orifice, and uncorks the bottle, or alternatively after unscrewing upper portion 8 of capsule 4, the user aligns blade 28 against the external neck of bottle 2 at the lip or collar of the bottle, inserts or slips it between the exterior surface of bottle 2 and top portion 10 of lower portion 6. The user then forces or slithers blade 28 down along the neck of bottle 2 to stretch the top portion 10, as seen in FIG. 4B, until the bottom side of the ring 27 abuts the bottle's orifice. Using arm 30 to maintain the position of blade 28, assembly 24 is then rotated around the neck of bottle 2 (alternatively, bottle 2 can be rotated while holding assembly 24 in place), while maintaining pressure inward and downward, until trench 12 has been formed around the neck of bottle 2. Blade 28 is then removed from trench 12. Since capsule 4 is generally made of very thin (e.g., ˜100 μm) polyvinyl chloride (PVC), expandable polyethylene (EPE), tin, aluminum, or the like, the insertion of blade 28 and its rotation around the neck of bottle 2 will allow top portion 10 to be stretched to form trench 12.

FIGS. 4C-4D depict yet another embodiment in which assembly 24 includes a shoulder 32 extending outwardly from ring 24. Shoulder 32 is spaced from and extends substantially parallel to blade 28 and helps prevent inadvertent damage to blade 28 and to help prevent blade 28 from stabbing/hurting the operator when the device is not being used. In certain embodiments the tip of blade 28 may be tapered, and the distance between the tip of blade 28 and shoulder 32 may be no more than approximately 0.01 mm.

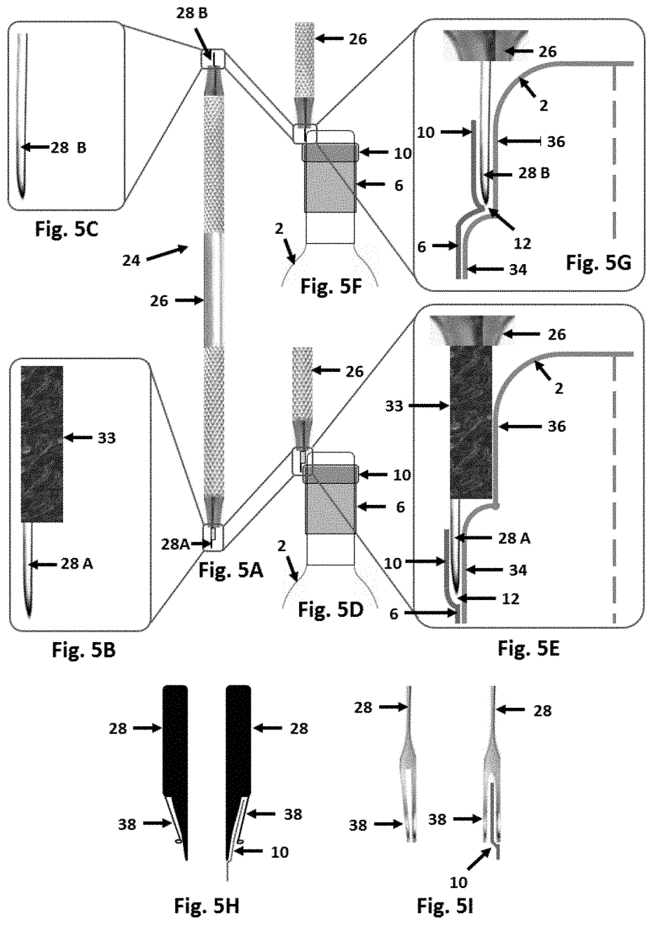

FIGS. 5A-G depict yet another embodiment assembly 24 in which housing 26 has a cylindrical pen-like shape, and a first blade 28A at one end and a second blade 28B at its opposed end. In certain embodiments, first blade 28A is shorter than second blade 28B. Housing 26 may include a block 33 from which blade 28A extends, as seen FIG. 5B. In use, as seen in FIG. 5D-E, as blade 28A is inserted between a collar 34 of bottle 2 and top portion 10 and top portion is stretched, block 33 slides along a lip 36 of bottle 2, and blade 28 moves downwardly until block 33 engages the top edge of collar 34, thereby forming trench 12.

As seen in FIGS. 5F-G, when the longer blade 26B is inserted between bottle 2 and top portion 10, it is inserted between lip 36 of bottle 2 and top portion 10, thereby forming trench 12. In certain embodiments, as seen in FIGS. 5H-I, blade 28 may include a stabilizer arm 38 that extends along and substantially parallel to the tip of blade 28, which serves to sandwich top portion 10 between blade 28 and stabilizer arm 38, thereby protecting the thin top portion 10. Additionally, as described above, blade 28 and stabilizer arm 38 may be protected from inadvertent damage by a sleeve, and the sleeve may be retractable, i.e., it readily slides into housing 26 to expose blade 28 and stabilizer arm 38.

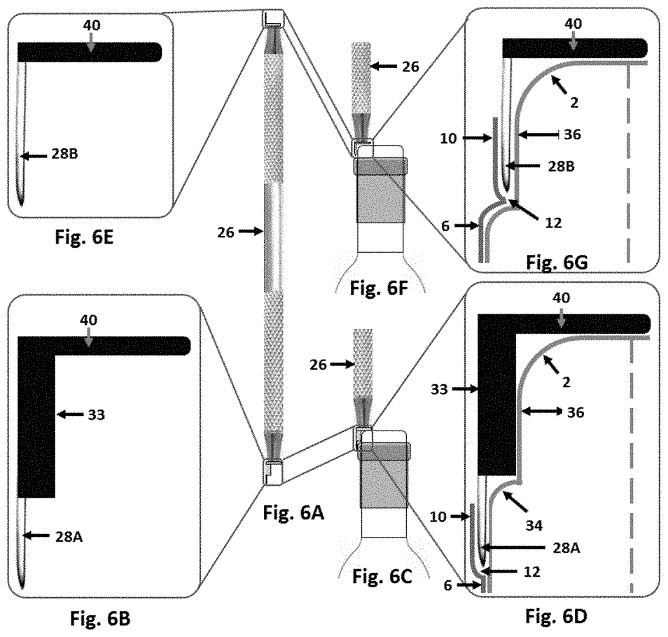

FIGS. 6A-G depict another embodiment of a cylindrical housing 26, in which the blade has a substantially L-shaped configuration. As seen in FIGS. 6B-D, blade 28A extends outwardly from block 33, and shoulder 40 extends outwardly from a top of block 33 substantially perpendicular to the longitudinal axis of blade 28A. In use, as seen in FIG. 6D, blade 28A is slipped between top portion 10 and collar 34, with block 33 sliding down along lip 36. Blade 28A is pushed downwardly between top portion 10 and collar 34 until block 33 engages the top edge of collar 34 and shoulder 40 engages the top of lip 36.

As seen in FIGS. 6E-G, at the other end of housing 26, blade 28B extends outwardly from shoulder 40. In use, blade 28B is slipped between top portion 10 and collar 34 and pushed downwardly until collar 40 engages the top of lip 36.

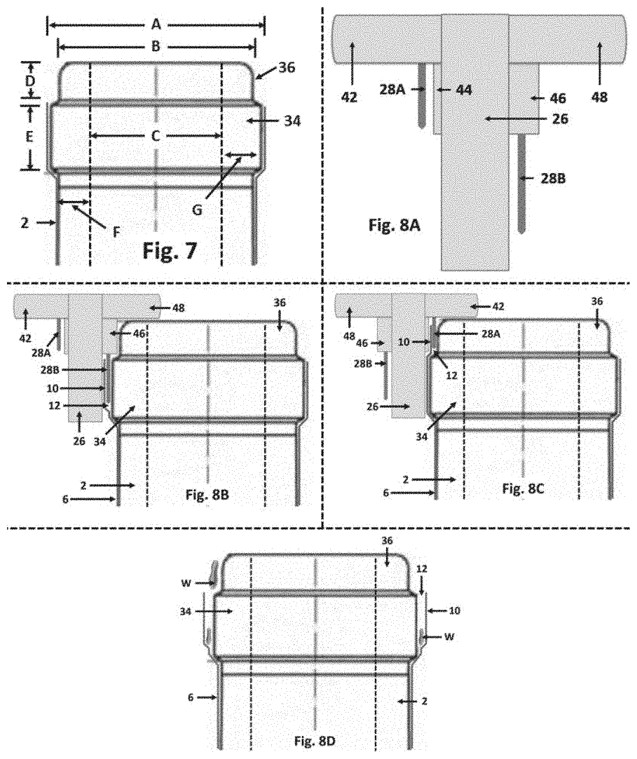

FIG. 7 illustrates that bottle 2 with capsule 4 thereon (with the top of the capsule removed) may have a collar exterior diameter A of approximately 28-31 mm, bottle 2 with capsule 4 thereon may have a lip exterior diameter B of approximately 25-27 mm, bottle 2 may have an orifice diameter C of approximately 17-20 mm, lip 34 may have a height D of approximately 1-2 mm, collar 34 may have a height E of approximately 9-14 mm, lip 36 may have a wall thickness F of approximately 3-4 mm, and collar 34 may have a wall thickness G of approximately 4-5 mm.

FIGS. 8A-D illustrate the use of substantially T-shaped housing 26 with a shorter blade 28A extending downwardly from a first arm 42. A block 44 extends downwardly along housing 26 in the direction of blade 28A. In use, blade 28A is slipped between lip 36 and top portion 10 and is pushed downwardly until first arm 42 engages a top of lip 36 to form trench 12.

Longer blade 28B extends downwardly from a block 46 positioned beneath second arm 48. In use, blade 28B is slipped between collar 34 and top portion 10 and is pushed downwardly until second arm 48 engages a top of lip 36 to form trench 12. As seen in FIG. 8D, when trench 12 is formed, drops W of wine can fall into and be captured in trench 12.

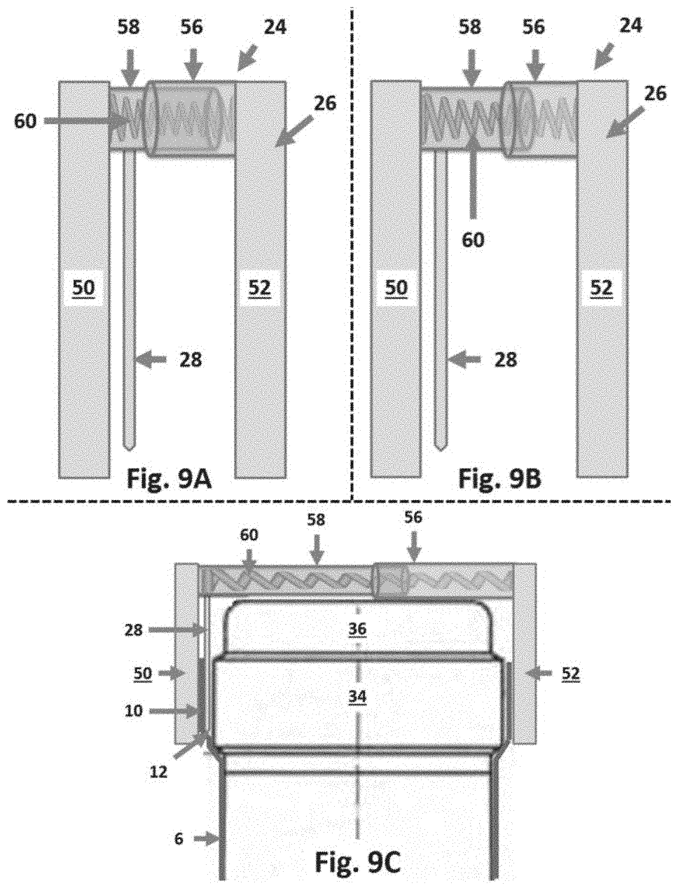

FIGS. 9A-C depict yet another embodiment, in which housing 26 is a substantially U-shaped assembly with a first wall 50, a second wall 52 spaced from first wall 50, and a connecting member 54 extending between first wall 50 and second wall 52. Connecting member 54 includes an outer cylinder 56 and an inner cylinder 58 movable within outer cylinder 56. A biasing member or spring 60 is seated within inner cylinder 58 and serves to provide tension, thereby providing resistance to a force moving second wall 52 away from first wall 50. Blade 28 extends downwardly from inner cylinder 58 proximate first wall 50.

At rest, spring 60 keeps the opposing walls 50, 52 at a distance that is less than that of the external diameter of bottle 2. When the end of bottle 2 is inserted into housing 26, first wall 50 and second wall 52 are forced apart, stretching spring 60. As force is applied by the user to the top of housing 26, blade 28 is inserted between top portion 10 and bottle 2, thereby forming trench 12 as housing 26 is rotated around bottle 2.

In the illustrated embodiment, as seen in FIG. 9C, apparatus 24 is sized such that walls 50 and 52 are positioned on the exterior of bottle 2. It is to be appreciated that apparatus 24 could be sized such that first wall 50 is positioned on the exterior of bottle 2 and second wall 52 extends into bottle 2 such that only the sidewall of bottle 2 is captured between first wall 50 and second wall 52.

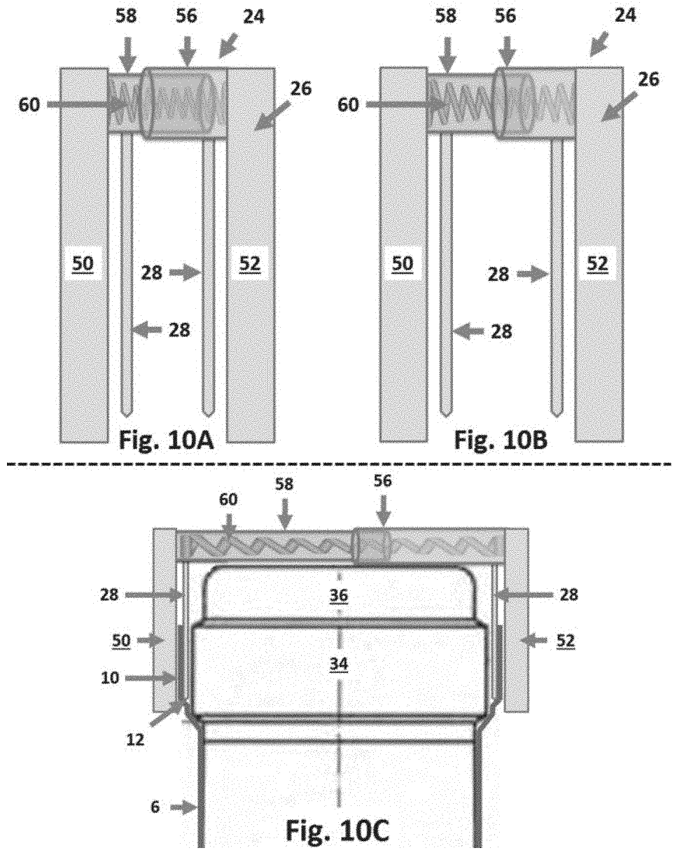

FIGS. 10A-C illustrate an embodiment similar to that of FIGS. 9A-C. In this embodiment, housing 26 includes a pair of blades 28, with one blade 28 extending downwardly from inner cylinder 58 and the other blade 28 extending downwardly from outer cylinder 56.

It is to be appreciated that more than two walls can be included in such an assembly 24. For example, 4, 6, 8, or more walls could be held together with springs 60 extending between opposed walls, and pairs of blades 28 extending downwardly between each pair of opposed walls. The plurality of blades 28 would be slipped between top portion 10 and bottle 2 as described above, and as housing 26 is rotated, top portion 10 is stretched to form trench 12.

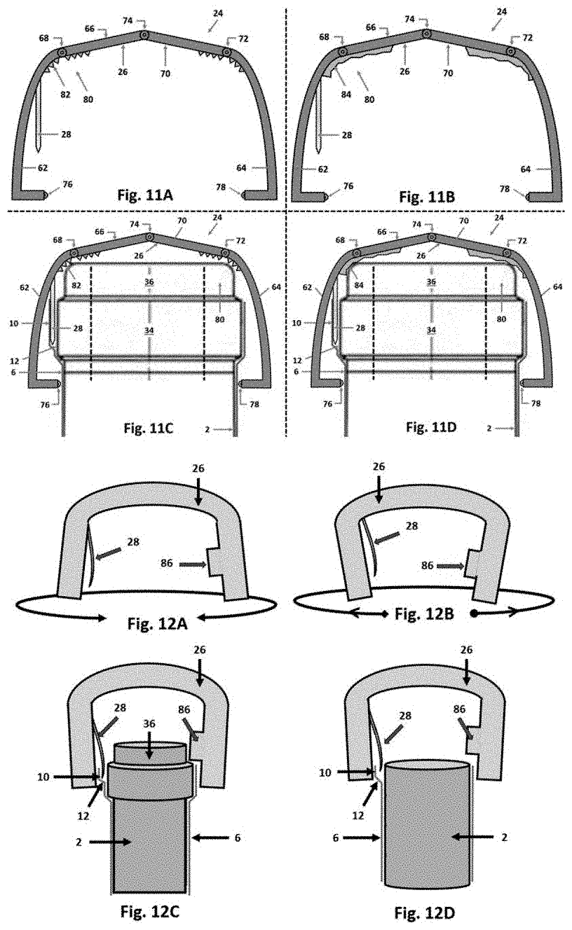

FIGS. 11A-D depict another embodiment in which housing 26 of assembly 24 is formed of a plurality of walls connected to one another by hinges. A first wall 62 is spaced from an opposing second wall 64. A third wall 66 is pivotally connected to first wall 62 by a first hinge 68. A fourth wall 70 is pivotally connected to second wall 64 by a second hinge 72. Third wall 66 is pivotally connected to fourth wall 70 by a third hinge 74.

A first projection 76 extends inwardly from an outermost end of first wall 62, and a second projection 78 extends inwardly from an outermost end of second wall 64. First and second projections 76, 78 may be freely rotating balls or non-rotating elements made of low resistance or slippery material. Blade 28 extends downwardly within housing 26 such as from first wall 62. Thus, first wall 62 provides protection for blade 28. In use, first and second walls 62, 64 are engaged with the neck of bottle 2 during the insertion of blade 28 between top portion 10 and bottle 2. An engagement assembly 80 is provided on the underside of housing 26 to hold it in position on top of bottle 2. In the embodiment shown in FIGS. 11A and 11C, engagement assembly 80 includes a plurality of step-like projections. In the embodiment shown in FIGS. 11B and 11D, engagement assembly 80 is formed of a pliable material 84, which is designed to engage and grip the top of bottle 2.

FIGS. 12A-D depict another embodiment in which housing 26 is a substantially U-shaped member with blade 28 extending downwardly into the mouth of the U-shape. A stopping block 86 extends inwardly from housing 26 opposite blade 28. Housing 26 may be made of a malleable material (e.g., plastic/metal) in such an embodiment. In use, as seen in FIGS. 12C-D, housing 26 is held against bottle 2 and blade 28 is inserted between top portion 10 and bottle 2 as described above. In the embodiment illustrated in FIG. 12A, housing 26 is formed such that in its non-use condition the mouth of the U-shape is wider than the outer diameter of bottle 2. To use such an embodiment, housing 26 is squeezed to engage bottle 2, as shown with the arrows in FIG. 12 A, and then trench 12 is formed with blade 28.

In the embodiment illustrated in FIG. 12B, housing 26 is formed such that in its non-use condition the mouth of the U-shape is narrower than the outer diameter of bottle 2. To use such an embodiment, the upper end of bottle 2 is inserted into the mouth of the U-shaped housing 26 such that housing expands, as illustrated by the arrows in FIG. 12B, and then trench 12 is formed with blade 28.

Stopping block 86 serves to position housing 26 appropriately, i.e., for bottles with a collar (FIG. 12C), stopping block 86 is held against lip 36 above collar 34. For bottles 2 that do not have a collar (FIG. 12D), stopping block 86 engages the top of bottle 2.

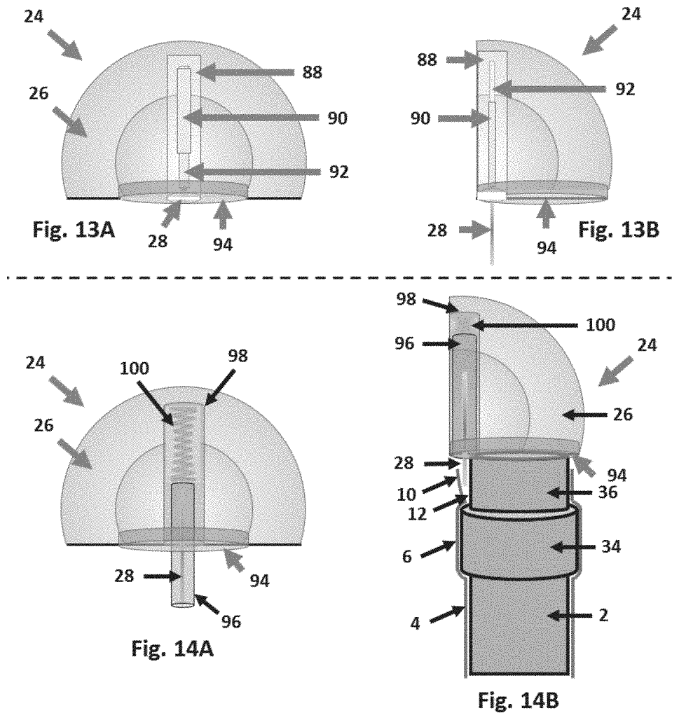

FIGS. 13A-B depict another embodiment in which blade 28 movably resides inside housing 26 within a chamber 88 when not in use. Blade 28 is attached to a retractable strip 90 that slides vertically along a track 92, thereby allowing blade 28 to move in an out of housing 26. Housing 26 may include a positioning indent 94 that allows the top of bottle 2 to more easily be oriented with respect to housing 26 as the user begins to use assembly 24.

FIGS. 14A-B depict another embodiment in which blade 28 is fixed with respect to housing 26, and is stored within a movable exterior sleeve 96. Exterior sleeve 96 is received in a chamber 98 formed in housing 26. A biasing member such as a compression spring 100 serves to keep exterior sleeve 96 in an extended position outside of housing 26 when assembly 24 is not in use. In use, as seen in FIG. 14B, the user presses down on housing 26, causing exterior sleeve 96 to move upwardly against compression spring 100 into chamber 98. Blade 28 can then be used to form trench 12 as described above. Positioning indent 94 ensures that the top of bottle 2 is oriented properly with respect to housing 26 as the user begins to use assembly 24.

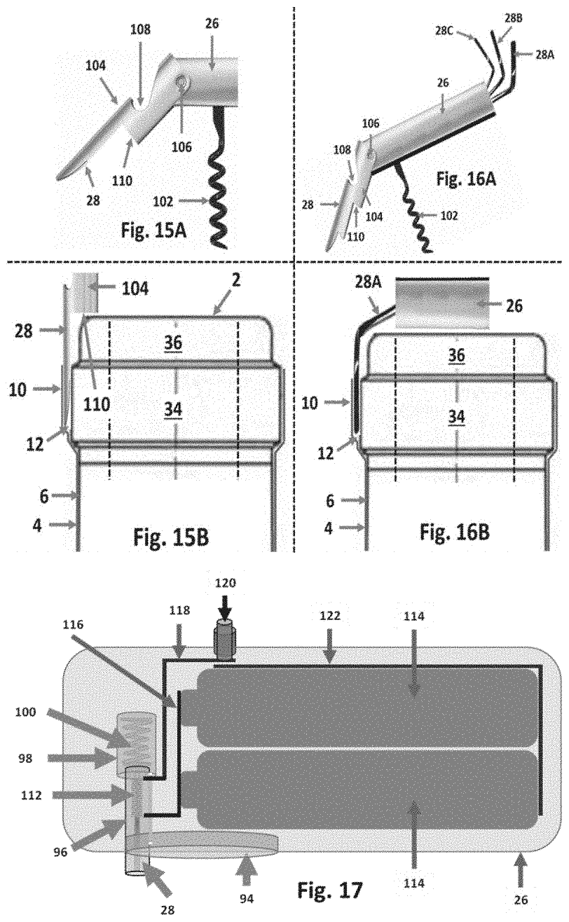

FIGS. 15A-B depict another embodiment in which housing 26 includes a corkscrew 102. Blade 28 is formed as part of an arm 104 that is pivotally attached to housing 26 by way of a hinge 106. Arm 104 may include a notch 108 that acts as a bottle opener to pry caps off bottles, such as beer bottles. Arm 104 may include a shoulder 110. In use, as seen in FIG. 15B, blade 28 is inserted between top portion 10 and bottle 2 until shoulder 110 engages the top of lip 36 of bottle 2.

FIGS. 16A-B depict an embodiment that is similar to that shown in FIGS. 15A-B. In this embodiment, an additional plurality of blades 28A-C, having different lengths (e.g., 1 mm, 2 mm, 5 mm, etc.) and shape (e.g., flat, round, U-shaped, pointed, blunt, etc.), are pivotally attached to housing 26. In use, as seen in FIG. 16B, the selected blade, such as blade 28A, is oriented to extend outwardly from housing 26. Blade 28A is then used as discussed above to form trench 12.

FIG. 17 depicts another embodiment, like that of FIGS. 14A-B, in which blade 28 is fixed with respect to housing 26, and is stored within a movable exterior sleeve 96. In this embodiment, a heating coil 112 is positioned between compression spring 100 and blade 28. Heating coil may be coiled around an upper end of blade 28. A battery 114, or more than one battery 114, is positioned within housing 26 and provides power to heating coil 112. Battery may be a rechargeable battery in certain embodiments.

A first conductor 116 connects the positive terminals of battery 114 to heating coil 112, a second conductor 118 connects heating coil 112 to a switch 120, and a third conductor 122 connects switch 120 to battery 114. When the button of switch 120 is fully depressed, it forces second conductor 118 against third conductor 122 to complete the circuit. When the push button is released second conductor 118 assumes its original position (i.e., is no longer in contact with third conductor 122). When the circuit is closed, heating coil 112 heats up and warms blade 28, thereby allowing blade 28 to soften upper portion 10, facilitating the stretching of upper portion 10 to form trench 12.

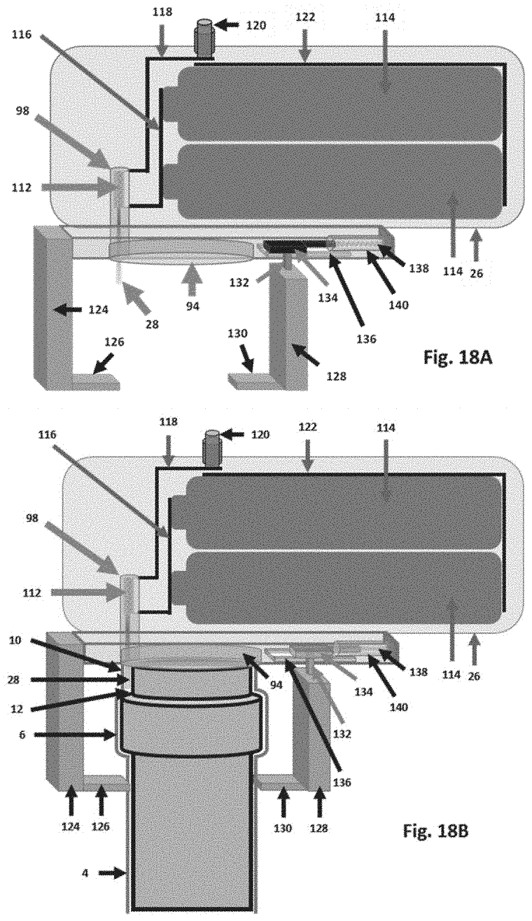

FIGS. 18A-B shows another embodiment with a heating coil 112 in housing 26. In this embodiment, a first wall 124 extends downwardly from and is fixed to housing 26. A first shoulder 126 extends inwardly from an outermost end of first wall 124 and serves to help capture bottle 2 as blade 28 forms trench 12. A second wall 128 is spaced from first wall 124. A second shoulder 130 extends inwardly from an outermost end of second wall 128 and cooperates with first shoulder 126 to help capture bottle 2 as blade 28 forms trench 12.

An upper end of second wall 128 includes a neck 132 that is connected to a sliding block 134. Sliding block 134 moves along a sliding track 136. A compression spring 138 is received in cylindrical chamber 140 and serves to bias second wall 128 toward first wall 124. In use, first shoulder 126 and second shoulder 130 are compressed against the neck of bottle 2 as blade 28 is used to form trench 12.

FIGS. 19A-B depict yet another embodiment in which a motor 142 resides within housing 26. Motor 142 is configured to separately rotate blade 28, a capsule cutter 144, both of which are residing within a transparent sleeve 146 that is located beneath housing 26, and a corkscrew 147. A cork chamber 149 may be included in housing 26 and serve to receive the cork from bottle 2 as it is opened. Sleeve 146 may be formed of two separate pieces, or halves, each of which can be pivotally connected to housing 26 with a hinge 148. Blocks 151 at lower ends of the two halves of sleeve 146 serve to capture the neck of bottle 2 when the sleeve halves 146 are squeezed together. A heating element ring 150 may also be positioned within transparent plastic sleeve 146 and serves to soften top portion 110.

In use, a push button on/off switch 152 that is activated when its button is pressed in when the two sides of sleeve 146 are pressed towards each other. The rotating capsule cutter 144, which is attached to a first rotating ring 154 and a first rotating shaft 156, then rotates, with the capsule cutter 144 having the capacity to move (along the X axis) with a first retractable screw 158. This movement can be stopped with a position sensor/detector” (not shown) once the sensor contacts the capsule 4 wrapping the bottle's neck. Blade 28, which is attached to a second rotating ring 160 and a second rotating shaft 162. Rotates as well. Blade 28 has the capacity to move with a second retractable screw 134 along the X axis and with a third retractable screw 166 along the Y axis. The heating element ring is suited for heating of capsule 4 and thereby facilitating the insertion of blade 28 and the expansion of top portion 10. Since the peak absorption of plastics like PVC is ˜3,500 nm, a far infrared emitter [FIR] heating element, which can heat up to ˜100° C., is suited for heating of capsule 4.

It is to be appreciated that the embodiment of FIGS. 19A-B may include only a rotating blade, which can be heated, and may not include the rotating capsule cutter or the corkscrew.

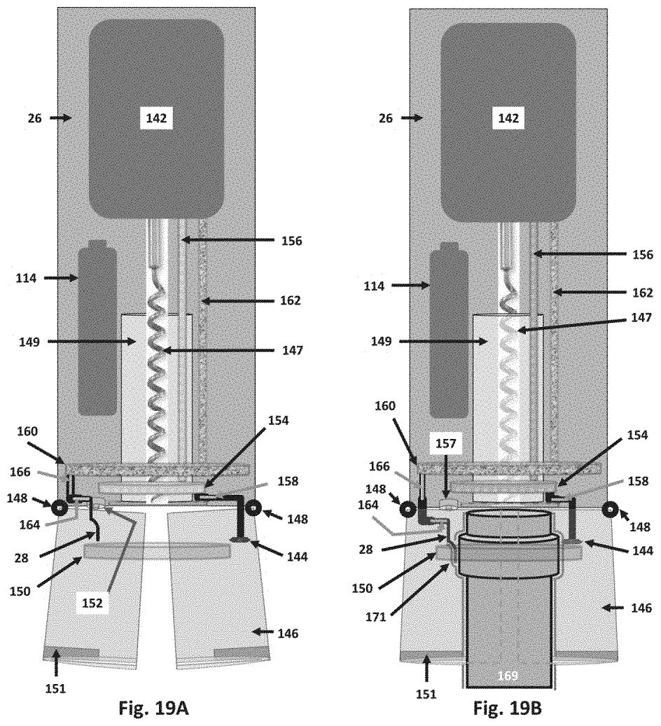

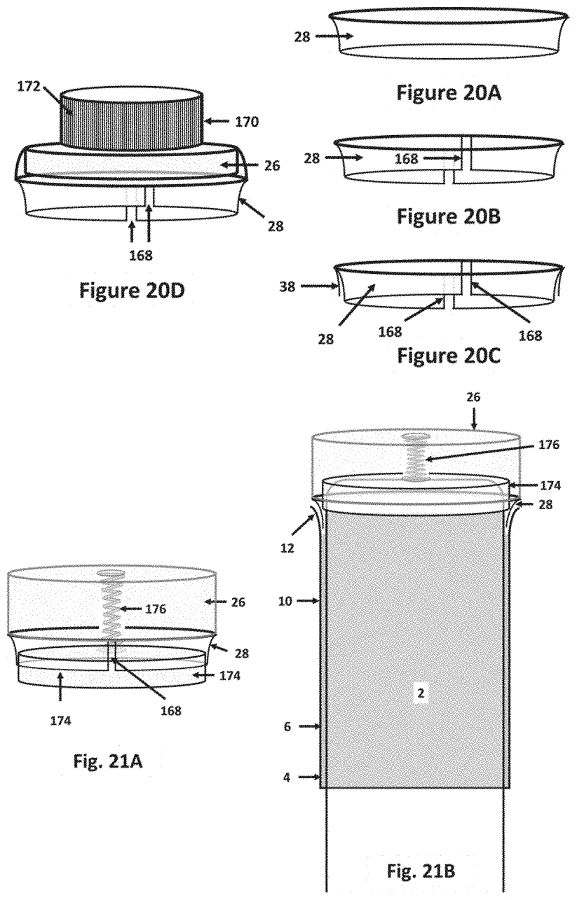

Alternative embodiments of blade 28 are illustrated in FIGS. 20A-C, in which blade 28 is donut-shaped and, therefore, can be slipped down between top portion 10 and bottle 2 and extend about an entire periphery of bottle 2 to form trench 12 without the need to rotate blade 28. In certain embodiments, as seen in FIGS. 20B-C, blade 28 can include one or more slits 168, which serve to provide blade 28 with flexibility. Any number of slits 168 can be formed in blade 28, thereby converting a single blade 28 into a plurality of arc segments. The separate arc segments separated by slits 168 ensure the tight fitting of blade 28 around the neck of different bottles 2, whose external diameters may slightly differ, i.e., when the assembly 24 is pressed against bottle 2, blade 28 will bend/expand radially outwards as needed to accommodate the specific diameter of the neck of bottle 2. In certain embodiments, a stabilizer arm 38 may extend along and substantially parallel to the blade 28, which serves to sandwich top portion 10 between blade 28 and stabilizer arm 38, thereby protecting the thin top portion 10.

In certain embodiments, as illustrated in FIG. 20D, the donut-shaped blade of FIGS. 20A-C can be incorporated on a housing 26, which has a cap 170 seated on top of housing 26. Cap 170 may be include vertically extending ridges 172 about its periphery, which provide enhanced grip for the user.

FIGS. 21A-B depict another embodiment in which a positioning cap 174 is received within housing 26, and is biased outwardly by a spring 176. In use, as seen in FIG. 21B, the user properly positions bottle 2 with respect to housing 26 by locating the top of bottle 2 within positioning cap 174, and then presses down on housing 26, forcing blade 28 between outer portion 10 and bottle 2 to form trench 12.

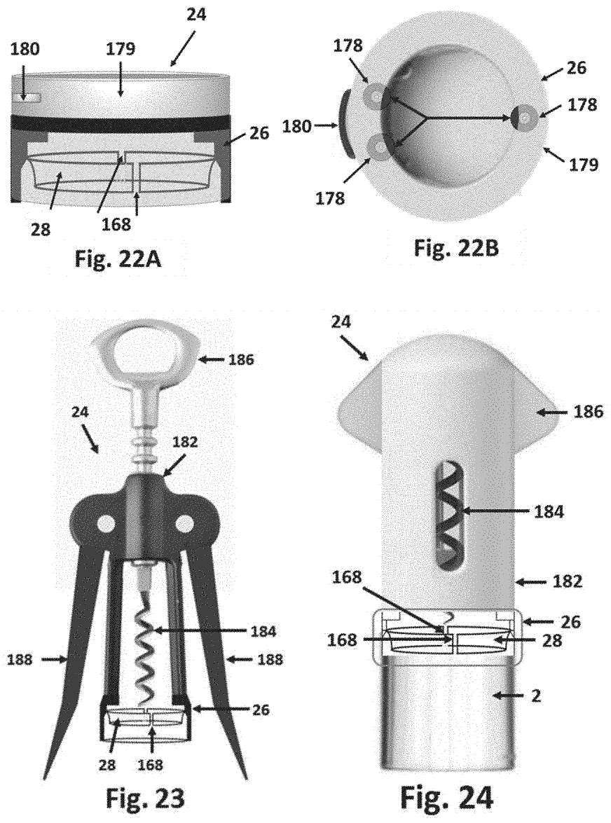

FIGS. 22A-B depict another embodiment in which housing 26 includes one or more blades 178 in a cutting cap 179 that is removably attached to the top of housing 26. Blades 178 are designed to cut through capsule 4. The user places cutting cap 179 on the top of bottle 2, and presses a knob 180 that is operably connected to blades 178, and rotates assembly 24 around the top of bottle 2. After removing the cut off portion of capsule 4, bottle 2 is then uncorked. Assembly 24 is then pressed down so that blade 28 is forced between outer portion 10 and bottle 2 to form trench 12.

FIG. 23 depicts another embodiment in which assembly 24 includes a bottle opener 182 secured to a top of housing 26. Bottle opener 182 may be a conventional hand operated opener with a corkscrew 184, a handle 186 at an upper end of the corkscrew that is used to insert the corkscrew into the cork, and a pair of arms 188 that are used to lever the corkscrew out. As shown here, this embodiment may include the donut-shaped blade 28.

FIG. 24 depicts another embodiment that is similar to that of FIG. 23, in which a bottle opener 182 is attached to housing 26. This bottle opener includes a corkscrew 184 that is operated simply by twisting handle 186, which may be formed of arms extending outwardly from opposed sides of bottle opener 182.

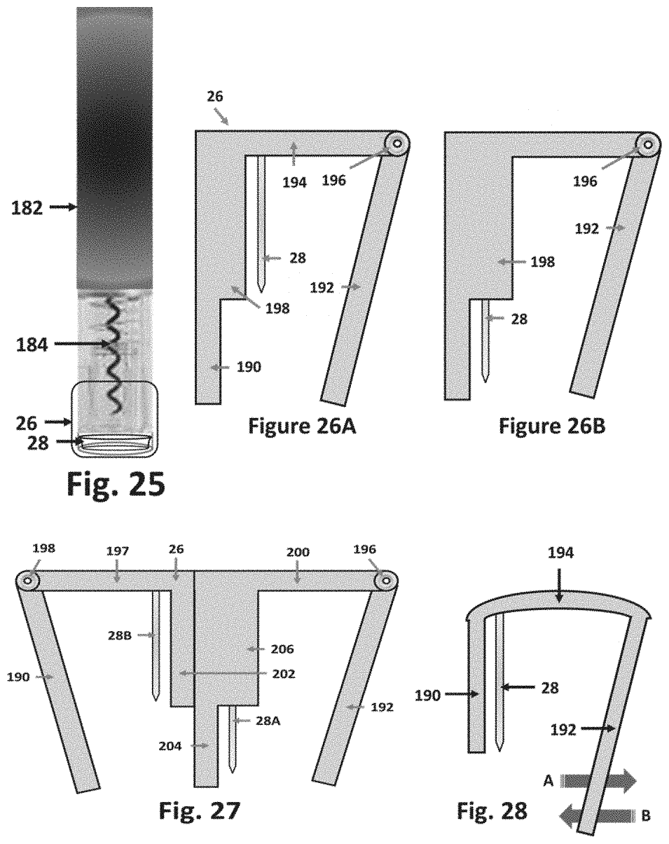

FIG. 25 depicts another embodiment in which a bottle opener 182 is attached to housing 26. This bottle opener 182 includes a battery (not visible) within housing 26 that serves to provide power to rotate corkscrew 184. The battery may be a rechargeable battery. Such an embodiment may include a heating coil, as described above, to warm top portion 10 to facilitate stretching it to form trench 12.

FIGS. 26A-B depict embodiments in which housing 26 includes a first wall 190 and a second wall 192 spaced from first wall 190, and a third wall 194 connecting first wall 190 to second wall 192. Second wall 192 may be pivotally connected to third wall 194 by way of a hinge 196. As seen in FIG. 26A, blade 28 extends downwardly from third wall 194 inwardly of a block 198 formed on an interior of first wall 190. Block 198 can serve to engage the top of a collar 34 of a bottle 2, as described above with respect to other embodiments. As seen in FIG. 26B, blade 28 can extend downwardly from a bottom of block 198, with block 198 serving to engage the top of a collar 34 of a bottle 2, as described above with respect to other embodiments These embodiments of housing 26 could be positioned on opposed ends of a cylindrical pen-like shaped housing 26, as illustrated in FIG. 5A above.

It is to be appreciated that first and second walls 190 and 192 can be positioned on the exterior of bottle 2, or they can be sized such that first wall 190 is positioned on the exterior of bottle 2 and second wall 192 extends into bottle 2 such that only the sidewall of bottle 2 is captured between first wall 190 and second wall 192.

FIG. 27 depicts an embodiment somewhat like that of FIGS. 26A-B, in which first wall 190 is pivotally connected to a first arm 197 of a T-shaped housing 26 by way of a hinge 198, and second wall 192 is connected to an opposed second arm 200 of the T-shaped housing 26 by way of hinge 196. A longer blade 28B is spaced outwardly from a first block 202 connected to the base leg 204 of the T-shaped housing 26, and a shorter blade 28A, which is shorter than blade 28B, extends downwardly from a second block 206 that is connected to an opposed side of base leg 204. The longer blade 28B can serve to form trench 12 about the lip 36 of a bottle 2, as described above with respect to FIG. 6G. The shorter blade 28A can serve to form trench 12 about the collar 34 of bottle 2, as described above with respect to FIG. 6D. It is to be appreciated that this embodiment could be attached at an end of a cylindrical pen-like shaped housing 26, as illustrated in FIG. 5A above.

It is to be appreciated that first wall 190 and base leg 204, or second wall 194 and base leg 204 can be positioned on the exterior of bottle 2 such that bottle 2 is captured therein. In other embodiments, first wall 190 can positioned on the exterior of bottle 2 and base leg 204 can extend into bottle 2 such that only the sidewall of bottle 2 is captured between first wall 190 and base leg 204. Similarly, second wall 192 can positioned on the exterior of bottle 2 and base leg 204 can extend into bottle 2 such that only the sidewall of bottle 2 is captured between second wall 192 and base leg 204.

FIG. 28 depicts another embodiment in which housing 26 is substantially U-shaped with first wall 190 connected to second wall 192 by way of third wall 194. Second wall 192 may be longer than first wall 190, and, therefore more easily flexed when forces in the direction of arrows A and B are exerted on second wall 192. Blade 28 may extend downwardly from third wall 194 inwardly from first wall 190. In this embodiment, housing 26 may be made of a bendable/flexible material (e.g., plastic/metal). The flexibility of housing 26 allows it to be more easily inserted onto and held in place on bottle 2.

It is to be appreciated that first and second walls 190 and 192 can be positioned on the exterior of bottle 2, or they can be sized such that first wall 190 is positioned on the exterior of bottle 2 and second wall 192 extends into bottle 2 such that only the sidewall of bottle 2 is captured between first wall 190 and second wall 192.

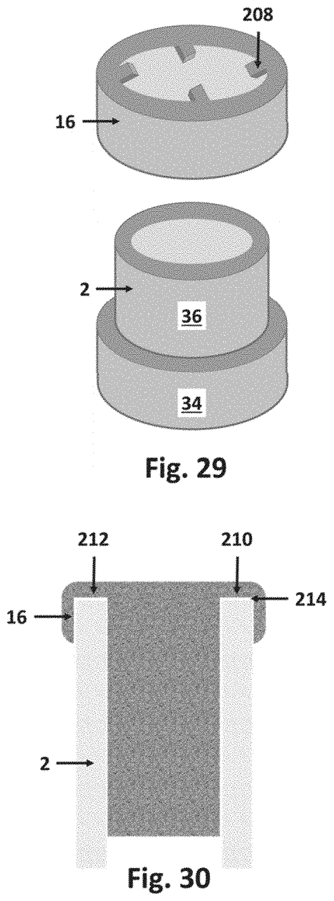

FIG. 29 depicts another embodiment of an inner sleeve 16 used in conjunction with capsule 4 (not shown here). As discussed above, inner sleeve 16 may be positioned on bottle 2 about lip 36. Capsule 4 is then secured about bottle 2 and inner sleeve 16. The user then removes the upper portion 8 of capsule 4 and opens bottle 2, either by unscrewing upper portion 8 in a screwcap configuration, or cutting and removing upper portion 8 and uncorking the bottle. The user then slips inner sleeve 16 off lip 36, thereby leaving trench 12 behind in the space formerly occupied by inner sleeve 16. In certain embodiments, inner sleeve 16 may include a retainer 208 at its upper edge, which serves to retain inner sleeve 16 on the top of bottle 2. In the illustrated embodiment, retainer 208 is formed of a plurality of tabs that inwardly toward in interior of inner sleeve 16. It is to be appreciated that retainer 208 can have any shape that serves to retain inner sleeve 16 of the top of bottle 2. For example, retainer 208 could be a circular disc with a central aperture that would allow a corkscrew to pass through retainer 208. Other suitable configurations for retainer 208 will become readily apparent to one skilled in the art, given the benefit of this disclosure.

FIG. 30 depicts another alternative embodiment of inner sleeve 16, in which it is part of a synthetic cork 210. A shoulder 212 extends outwardly from cork 210, and inner sleeve 16 extends downwardly from the outer edge of shoulder 212, thereby defining a groove 214 that receives the upper edge of bottle 2. As seen here, inner sleeve 16 and synthetic cork 210 may be a single unitary, or integral, structure. That is, they are a single monolithic piece of material as opposed to separate elements that are subsequently joined together. Suitable materials for such a synthetic cork are well known to those skilled in the art. In use, synthetic cork 210 is placed into the orifice of bottle 2 such that inner sleeve extends downwardly about the upper edge of bottle 2. Trench 12 is naturally formed when bottle 2 is decorked and inner sleeve 16 and cork 210 are removed from bottle 2.

It is to be appreciated that in view of the large number of embodiments described herein, that not all possible combinations of the various embodiments of assembly 24 are shown or described herein. Thus, although the use of a heating coil 112 to heat blade 28 may be shown and described in only some of the embodiments described above, it is to be appreciated that heating coil 112 could be used in many other embodiments. The same holds true for many or all of the other features disclosed above.

Thus, while there have been shown, described, and pointed out fundamental novel features of various embodiments, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is the intention, therefore, to be limited only as indicated by the scope of the claims appended hereto.

1.-7. (canceled)

8. An assembly for forming a trench in a capsule to be secured about a neck of a bottle, the assembly comprising:
a housing; and
a blade extending outwardly from the housing.

9. The assembly of claim 8, wherein the housing includes a ring, the blade extending outwardly from the ring, an arm extending outwardly from the ring, and a shoulder extending outwardly from ring and extending substantially parallel to the blade.

10.-11. (canceled)

12. The assembly of claim 8, wherein the housing includes a first wall, a second wall spaced from the first wall, and a connecting member extending between the first and second walls, the connecting member including an outer cylinder, and inner cylinder movable within the outer cylinder, and a biasing member contained within the inner cylinder, the blade extending outwardly from the connecting member.

13. The assembly of claim 8, wherein the housing includes a first wall, a second wall spaced from the first wall, a third wall connected to the first wall by a first hinge, a fourth wall connected to the second wall by a second hinge, and a third hinge connecting the third wall to the fourth wall.

14.-15. (canceled)

16. The assembly of claim 8, wherein the housing is a substantially U-shaped member with a stopping block extending inwardly toward an interior of the U-shaped member.

17.-19. (canceled)

20. The assembly of claim 8, further comprising a heating coil operably connected to the blade, a battery operably connected to the heating coil, and a switch operably connected to the heating coil.

21. (canceled)

22. The assembly of claim 21, further comprising a first stopping block formed on the first wall and a second stopping block formed on the second wall, the stopping blocks configured to engage an exterior of a bottle.

23. (canceled)

24. The assembly of claim 8, further comprising a motor positioned within the housing, and a battery operably connected to the motor, wherein the blade is operably connected to the motor and configured to rotate about a periphery of a bottle to be held in contact with the assembly.

25. The assembly of claim 24, further comprising a rotatable cutting disc positioned within the housing and operably connected to the motor.

26.-27. (canceled)

28. The assembly of claim 8, wherein the blade is donut-shaped.

29. The assembly of claim 28, further comprising a plurality of slits formed in the blade.

30.-32. (canceled)

33. The assembly of claim 8, wherein the assembly has dimensions sufficient for the assembly or device to fit or engage on top of a neck of a bottle or match the thickness of the wall of the neck of the bottle.

34. A method for making a trench in a protective sleeve secured about a neck of a bottle comprising
attaching an assembly comprising a housing and a blade extending outwardly from the housing to the protective sleeve secured about the next of the bottle, and
rotating the blade about a periphery of the bottle to create the trench in the protective sleeve.
